(19) United States
(12) Patent Application Publication
(10) Pub. No.: US 2010/0027518 A1
(43) Pub. Date: Feb. 4, 2010

(54) REAL-TIME VISUALIZATION OF WIRELESS NETWORK STATUS

(76) Inventor: Yu Wang, San Jose, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/183,982

(22) Filed: Jul. 31, 2008

(51) Int. Cl. H04W 4/00

(52) U.S. Cl. 370/338

(57) ABSTRACT

Status of a wireless network is visualized in real-time by collecting data from the network, including locations of the wireless network nodes, and displaying this information in a geographical information service (GIS) such as Google Earth. Node information such as node status may be gathered from nodes by a display node, or may be gathered and maintained by a node controller. Unity scaled antenna models may be used to display node coverage. Updates to network status may be polled by the display node, or by the network controller and pushed to the display node.

### CROSS REFERENCE TO RELATED APPLICATIONS

The present application is related to U.S. patent application Ser. No. 11/830,719 filed Jul. 30, 2007, and incorporated by reference herein.

### BACKGROUND OF THE INVENTION

The present invention relates to wireless networks, and in particular, to the problem of visualizing network status in real-time.

Wireless networks, such as those operating according to IEEE 802.11 standards typically provide wireless packet-based data services to clients in the network. These clients may include computers such as laptops, hand-held devices such as smart phones, scanners, and the like, as well as wireless infrastructure devices such as sensors and cameras. In one common implementation, a plurality of wireless access nodes, each typically a small purpose-built computer system with one or more wireless interfaces, also include a wired interface such as IEEE 803.2 Ethernet, to connect the access node back to a controller, which provides access to network services, as well as optionally providing functionality such as authentication, security, advanced mobility, and the like. In such a network, clients establish a wireless connection with an access node. Traffic to and from the client is passed to and from the access node wirelessly, and to and from the access node and the controller through the wired connection.

In a mesh network, rather than having each node wired to a controller, wireless access nodes establish wireless connections with each other, with only a small number of access nodes having wired access to a controller. In such a mesh network, clients also establish a wireless connection with an access node. But rather than traffic going wirelessly from client to access node, and from there by wired connection to the controller, in a mesh network, traffic first passes wirelessly from client to a first access node, and then wirelessly from that first access node through one or more other access nodes in the mesh network, until the traffic arrives at a root node or mesh portal, a node with a wired connection to the controller, and from there to the controller. The mesh connection between access nodes may be through the same radio system and/or same radio channels as used by client traffic, or a separate radio and/or band as used by client traffic.

As is known to the art, mesh networks may be self-organizing, and adaptive, shifting their interconnections as access nodes enter and leave the network, or other characteristics of the network or its operating environment change.

These wireless networks may cover large geospatial areas. Traditional network management systems use numerical values or two-dimensional graphics to display the status of nodes in the network, and of the network overall.

What is needed is a way to view wireless networks in real time.

### BRIEF DESCRIPTION OF THE DRAWINGS

The invention may be best understood by referring to the following description and accompanying drawings that are used to illustrate embodiments of the invention in which.

FIG. 1 shows a block diagram of a wireless network,

FIG. 2 shows a mesh network in a GIS,

FIG. 3 shows a mesh network in a GIS, and

FIG. 4 shows a network in a GIS.

### DETAILED DESCRIPTION

Embodiments of the invention relate to improved methods of visualizing wireless networks in real-time. A display node collects data from nodes in a wireless network, either directly through the nodes, or through a network controller. Data is displayed in real time using a geographic information service (GIS) or similar visualization platform. Node status and/or performance may be displayed in terms of signal strength, signal contours, or data rates. Updates may be polled by the display node, from the wireless nodes directly, or through the controller, or updates may be collected by the controller and pushed to the display node.

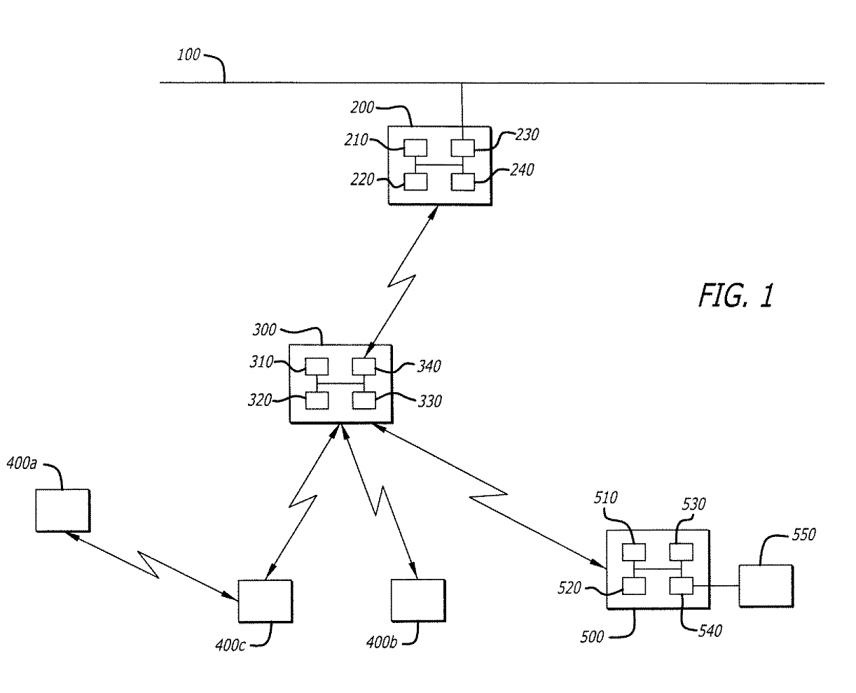

As shown in FIG. 1, network 100 such as an IEEE 802.3 Ethernet network is connected to controller 200. Controller 200 supports wired connections 240 to root access nodes 300. These root access nodes provide wireless communications to mesh nodes 400a, 400b, which in turn support nodes such as display node 500.

As is understood in the art, controller 200 is a purpose-built digital device having a CPU 210, memory hierarchy 220, and a plurality of network interfaces 230, 240. CPU 210 may be a MIPS-class processor from companies such as Raza Microelectronics or Cavium Networks, although CPUs from companies such as Intel, AMD, IBM, Freescale, or the like may also be used. Memory hierarchy 220 includes read-only memory for device startup and initialization, high-speed read-write memory such as DRAM for containing programs and data during operation, and bulk memory such as hard disk or compact flash for permanent file storage of programs and data. Network interfaces 230, 240 are typically IEEE 802.3 Ethernet interfaces to copper, although high-speed optical fiber interfaces may also be used. Controller 200 typically operates under the control of purpose-built embedded software, typically running under a Linux operating system, or an operating system for embedded devices such as VXWorks.

Similarly, as understood by the art, wired and wireless access nodes 300 and 400 are also purpose-built digital devices. These access nodes include CPU 310, memory hierarchy 320, and wireless interface 330. Root nodes 300 include wired interface 340. While wired interface 340 may not be present in mesh nodes 400, it may be present but not used for direct communication with controller 200. As with controller 200, the CPU commonly used for such access nodes is a MIPS-class CPU such as one from Raza Microelectronics or Cavium Networks, although processors from other vendors such as Intel, AMD, Freescale, and IBM may be used. The memory hierarchy comprises read-only storage for device startup and initialization, fast read-write storage such as DRAM for holding operating programs and data, and permanent bulk file storage such as compact flash. Wireless access nodes 300, 400 typically operate under control of purpose-built programs running on an embedded operating system such as Linux or VXWorks. Wireless interface 330 is typically an interface operating to the family of IEEE 802.11 standards including but not limited to 802.11a, b, g, and/or n.

Display node 500 is also a digital device, similarly having CPU 510, memory hierarchy 520, wireless interface 530, and I/O devices 540 and display 550. As examples, display node 500 may be a general purpose computer such as a laptop, or may be a purpose-built device. In a general-purpose computer, CPU 510 may be a processor from companies such as Intel, AMD, Freescale, or the like. In the case of purpose-built devices, Acorn or MIPS class processors may be preferred. Memory hierarchy 520 comprises the similar set of read-only memory for device startup and initialization, fast read-write memory for device operation and holding programs and data during execution, and permanent bulk file storage using devices such as flash, compact flash, and/or hard disks.

While shown using a wireless connection, display node 500 may communicate through wired or wireless interfaces.

According to an embodiment of the invention, the geographical locations of wireless nodes 300, 400 are known. This location data, for example latitude, longitude and optionally a height measurement such as height above average terrain (HAAT), may be stored with each node 300, 400, or may be maintained in a database, such as a database associated with controller 200, or with display node 500. The location information and node type, which may include information such as manufacturer and model, node name, identifiers such as MAC addresses, and the like, are used to construct a visual representation of each node. Status information is added to display node status. This information is displayed using a geographical information system (GIS) such as Google Earth from Google, Inc., ArcGIS from ESRI, or other similar system in a 3-D like manner.

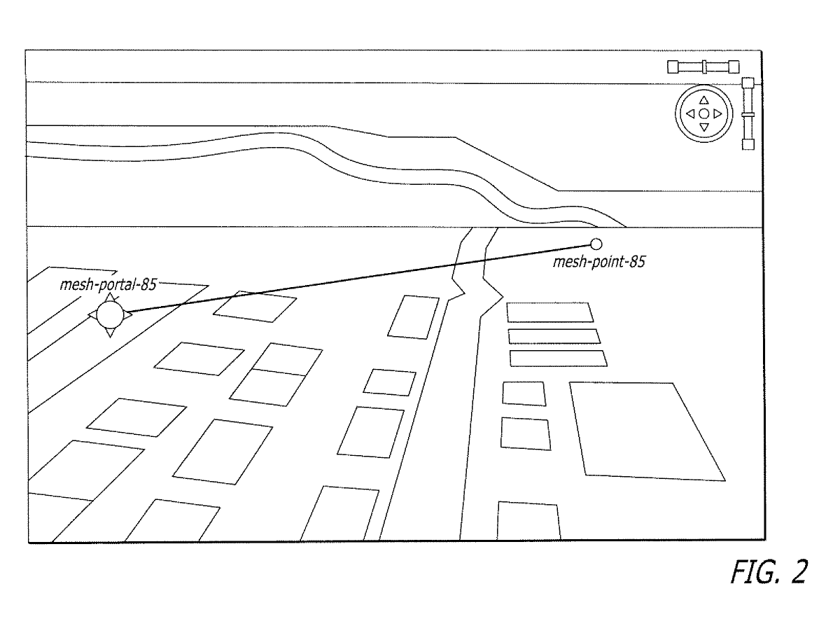

In networks using the mesh network topology, links may be shown among nodes. FIG. 2 shows two nodes in a mesh network using the Google Earth GIS. The line between the two nodes shows the mesh topology and parent-child relationship with the node named “mesh portal-85” the parent, and the node named “mesh point-85” the child. The color of the connecting line may be used to show the radio band used for the mesh connection. Particularly in mesh networks, showing the link topology is very useful.

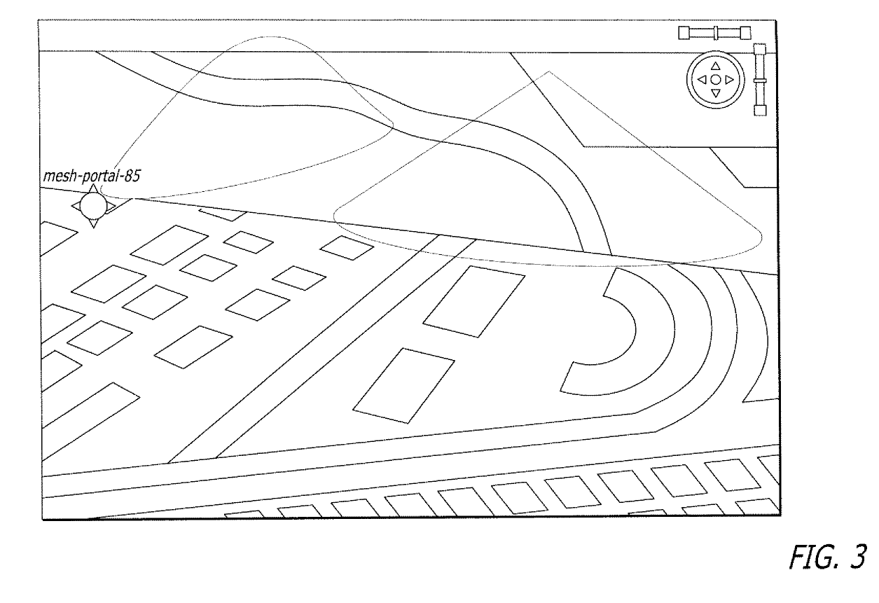

As shown in FIG. 3, information on the antenna type for each node may be used to display coverage. This antenna type information may be stored in the particular node, or in a database associated with controller 200 or display node 500. While simple antenna models may be used, such as generic sphere model, unity scaled models which more accurately represent the performance of each antenna are preferred. As has been disclosed, the unity model presents a three dimensional model of the antenna pattern rescaled from the logarithmic form commonly used in the art to a linear form which is more adaptable to the GIS. Such unity models may be created using modeling programs, or from measured performance data. Unity models as used in the invention represent the full three-dimensional response pattern of an antenna but are devoid of absolute scale, instead having relative scale.

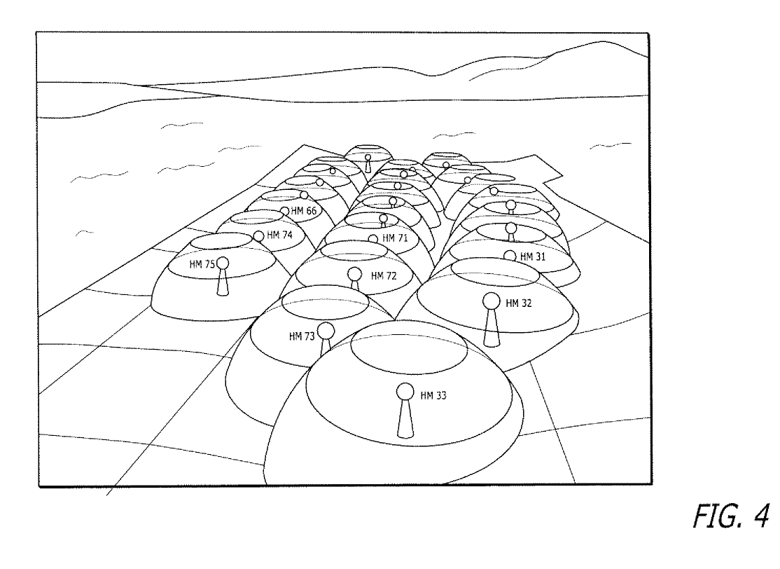

FIG. 4 shows greater three dimensional coverage in a GIS. Antenna patterns as displayed in the GIS may be scaled based on the transmit power of the particular node, or may be scaled based on the received signal strength of that node as received by other nodes. Color may be used to designate operating frequency, and shading may be used to denote variations such as signal strength or expected data rate contours.

Updates in visual displays may be obtained by display node 500 polling controller 200 for updates, by display node 500 polling nodes 300 and 400 directly for updates, or by having controller 200 maintain network status and pushing status updates to display node 500 using protocols known to the art. Such updates may include network connectivity, network topology, node status, and the like. Node parameters such as bandwidth in use and number of clients may be shown.

While the invention has been described in terms of various embodiments, the invention should not be limited to only those embodiments described, but can be practiced with modification and alteration within the spirit and scope of the appended claims. The description is this to be regarded as illustrative rather than limiting.

What is claimed is:

1. In a network with wireless nodes connected to a wireless node controller, a method of displaying the network at a display node comprising:
establishing the location of the wireless nodes in the network,
constructing a visual representation of the wireless nodes in the network,
collecting data from the wireless nodes in the network,
displaying at the display node the wireless nodes in the network at their established locations along with at least a portion of the collected data in a geographical information system (GIS), and
collecting updated data from the wireless nodes and updating the display at the display node of the at least a portion of the collected data in the geographical information system.

2. The method of claim 1 where the display node communicates directly with the wireless nodes.

3. The method of claim 1 where the display node communicates directly with the wireless node controller.

4. The method of claim 3 where the step of collecting data from the wireless nodes is performed by the wireless controller.

5. The method of claim 3 where the step of collecting data from the wireless nodes is performed by the display node.

6. The method of claim 1 where at least a portion of the wireless nodes are operated as a wireless mesh network, and the collected data displayed in the GIS includes at least an indication of the mesh topology by showing lines between connected wireless nodes in the mesh.

7. The method of claim 1 additionally comprising:
associating an antenna model with each wireless node, and
scaling the display of the antenna model associated with each node as a function of the collected data.

8. The method of claim 7 where the antenna model is a generic model.

9. The method of claim 7 where the antenna model is selected from a plurality of antenna models based on a predetermined antenna type.

10. The method of claim 9 where at least one antenna model in the plurality of antenna models is a unity scaled antenna model.

11. The method of claim 7 where the antenna model is scaled by node transmit power.

12. The method of claim 7 where the antenna model for a wireless node is scaled by the received signal strength of that wireless node as reported by another wireless node.

13. The method of claim 1 where the step of collecting updated data from the wireless nodes further comprises polling the wireless nodes by the wireless node controller.

14. The method of claim 1 where the step of collecting updated data from the wireless nodes further comprises polling the wireless nodes by the display node.

15. The method of claim 1 where the step of collecting updated data from the wireless nodes further comprises polling the wireless controller by the display node.

16. The method of claim 1 where the step of collecting updated data from the wireless nodes further comprises the wireless controller pushing updated data to the display node.

17. The method of claim 1 where the step of collecting updated data from the wireless nodes further comprises pushing updated data from the wireless nodes to the wireless controller.
